(19) United States
(12) Patent Application Publication
(10) Pub. No.: US 2024/0343216 A1
(43) Pub. Date: Oct. 17, 2024

(54) Vehicle Safety Guard System with Impact Detection

(71) Applicant: PUBLIC TRANSPORTATION SAFETY INT'L CORP., Los Angeles, CA (US)

(72) Inventor: Mark B. BARRON, Bel Air, CA (US)

(73) Assignee: PUBLIC TRANSPORTATION SAFETY INT'L CORP., Los Angeles, CA (US)

(21) Appl. No.: 18/294,595

(22) PCT Filed: Aug. 9, 2022
(86) PCT No.: PCT/US2022/039807

§ 371 Date: Feb. 2, 2024

Related U.S. Application Data
(60) Provisional application No. 63/234,450, filed on Aug. 18, 2021.

(51) Int. Cl. B60R 19/56; B60R 1/23

(52) U.S. Cl. CPC B60R 19/565; B60R 1/23; B60R 2300/80

(57) ABSTRACT

A safety guard is configured to extend down from a body portion of a vehicle for engaging animate and inanimate objects in order to prevent the objects from going under the vehicle. A detection system is also provided, including a plurality of sensors configured to sense an impact experienced by the safety guard and a control unit for analyzing the impact. The analysis can result in various actions being taken, including issuance of an impact warning, an evaluation on the cause of the impact, an assessment on any operator negligence associated with the impact and/or a notification regarding a need to replace the safety guard due to the impact.

### CROSS-REFERENCE TO RELATED APPLICATIONS

This application claims the benefit of U.S. Provisional Patent Application No. 63/234,450 filed Aug. 18, 2021 and entitled “Vehicle Safety Guard System with Impact Detection”. The entire content of this application is incorporated herein by reference.

### BACKGROUND OF THE INVENTION

### Field of the Invention

The present invention pertains to the art of vehicle safety devices and, more particularly, to a safety guard system mounted to and extending downward from one or more portions of a vehicle for engaging animate and inanimate objects in order to prevent the objects from going under the vehicle. Importantly, the safety guard system includes a detection system which senses when a guard portion impacts an obstruction. Data from the impact is analyzed to determine potential damage to the safety guard system. In addition, the data can be also analyzed to determine vehicle operational parameters in order to alert/notify appropriate personnel if the driver is operating the vehicle negligently.

### Discussion of the Prior Art

For a range of reasons, various transportation vehicles are designed with rather high ground clearances. For instance, school and commuter buses can have associated high ground clearances. Unfortunately, there are inherent dangers associated with the operation of vehicles with high ground clearances that are not found in other vehicles which have low ground clearances. The most serious of these injuries is a result of an individual slipping and falling in the road in front of the vehicle, resulting in the vehicle running over the individual. In addition, inanimate objects can undesirably run over and crushed by such a vehicle.

To address these concerns, it has been proposed in the art to mount a safety guard directly in front of wheels on a bus to establish a safety barrier between the wheels and objects. More specifically, as represented by U.S. Pat. Nos. 5,462,324 and 5,735,560, it is known to mount a safety barrier to undercarriage structure of a vehicle, such as a bus, with the safety barrier including a lower edge extending directly along a ground surface. The safety barrier is fixedly supported at various locations, such as to axle, frame and/or suspension structure. The safety barrier is mounted such that, if an object is encountered during movement of the bus, the safety barrier deflects the object out of the path of the vehicle wheels.

To properly function, such known safety barriers extend quite low to the ground over which the vehicle traverses. Generally, this distance is within 3-5 inches. Given this height, the safety barrier or guard can also engage fixed objects, such as curbs, edges of potholes, speed bumps and the like, which can damage the safety barrier, particularly if the contact occurs when the vehicle is being operated in an unsafe manner, such as at an excessive speed. With this in mind, although there exist various vehicle safety guard systems in the art, there is seen to exist a need for a safety guard system which can detect barrier impacts and record data regarding the impact, even enabling the data to be analyzed to determine the cause, degree and potential damage of the impact, as well as to assess the potential for operator error in connection with the impact.

### SUMMARY OF THE INVENTION

The present invention is directed to providing a vehicle safety guard system mounted to and extending downward from select body portions of a vehicle, such as a high clearance school or commuter bus, wherein the safety guard not only functions to prevent animate objects from going under the vehicle but incorporates a detection system to sense and analyze impacts experienced by the safety guard. Overall, the safety guard functions to engage and deflect individuals or other animate objects lying in the path of the vehicle, thereby preventing the individuals or other animate objects from being run over by the vehicle. For this purpose, the safety guard extends down from a body portion of the vehicle, such as below the front bumper and/or between the front and rear wheels along a side of the vehicle, to just above the vehicle support surface, e.g., in the range of about 3 inches or less from the support surface.

In accordance with the invention, sensors, which are preferably built into the safety guard, are used to determine if the safety guard experiences an impact, with signals from the sensors being evaluated by an overall computerized monitoring and evaluating system to determine the likelihood of damage to the safety guard. If damage is likely, a warning will be issued, such as in the form of an audible or visual warning to the vehicle operator or a notification to a remote supervisory or service center. The sensors can include various known types of impact sensors working in conjunction with one or more safety guard mounted cameras that can be used to actually record data associated with the impact. The data can also be analyzed in evaluating the cause of the impact, including whether the impact was due to vehicle operator negligence or other error that warrants further review and supervisory notification.

With this overall construction, an individual who slips and falls under the vehicle or in the vehicle's path will engage the safety guard and be prevented from going completely under the vehicle. In addition, any impact by the safety guard with an individual or inanimate object, such as a curb, pothole, speed bump or the like, will be sensed and analyzed to assure that the safety guard is not damaged, and the vehicle driver is properly operating the vehicle.

Additional objects, features and advantages of the present invention will become more readily apparent from the following detailed description of preferred embodiments when taken in conjunction with the drawings wherein like reference numerals refer to corresponding parts in the several views.

### BRIEF DESCRIPTION OF THE DRAWINGS

FIG. 1 is a perspective view of a commuter bus-type vehicle having mounted thereto a safety guard system with damage detection in accordance with an embodiment of the invention; and

FIG. 2 is a block diagram of a control system for sensing and responding to impacts by the safety guard.

### DETAILED DESCRIPTION OF THE INVENTION

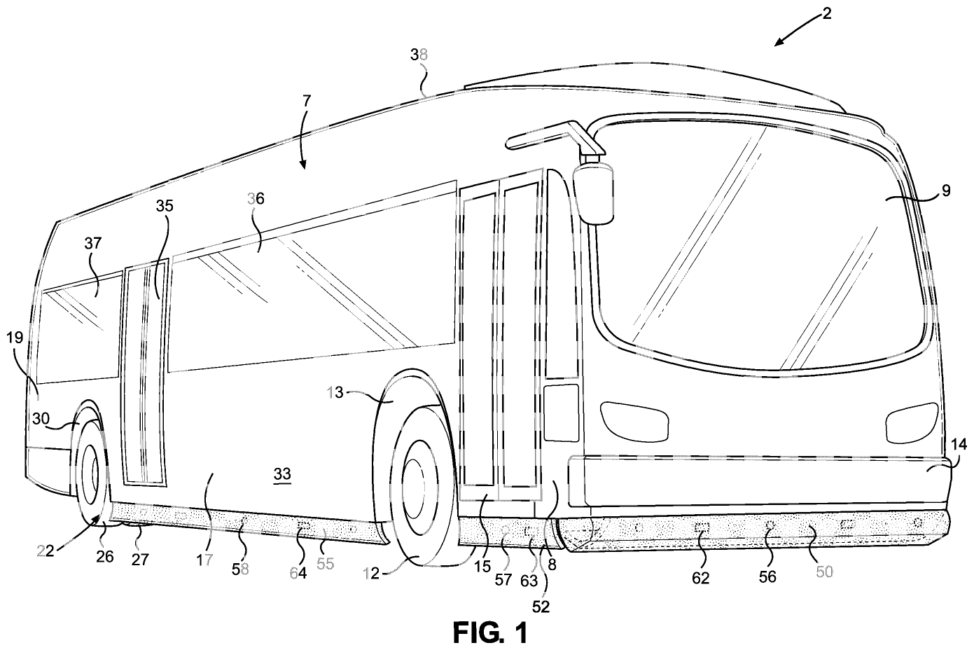

With initial reference to FIG. 1, an exemplary vehicle 2, shown as a commuter bus, including a body 7 having a front end 8 having a windshield 9, front steerable wheels one of which is shown at 12 within a wheel well 13, and a front bumper 14. Arranged directly forward of front wheel 12 is shown a forwardmost side door 15. Body 7 also includes a middle section 17 and a rear end section 19. Supporting rear end section 19 is a pair of rear wheel assemblies, one set of which is shown at 22 to include dual wheels 26 and 27 arranged in a wheel well 30 created in a side panel 33 of vehicle body 7. Just in front of rear wheel assembly 22 alongside panel 33 is a rearmost side door 35. Also provided in side panel 33 are various fore-to-aft spaced windows 36 and 37 which are vertically arranged below a roof 38. In accordance with this exemplary embodiment of the invention, vehicle 2 includes one or more safety guards which are, at the very least, incorporate sensors of a damage detection system. More specifically, in the exemplary embodiment shown in FIG. 1, a front safety guard 50 is shown fixed to and extending downward from front end 8 below bumper 14, a forward side safety guard 52 extending below door 15, and at least one side safety guard 55 extends below side panel 33 between front and rear wheels 12 and 22.

For the sake of completeness, safety guards 50, 52 and 55 are preferably formed of a highly durable, impact resistant urethane material that is abrasion resistant, corrosion proof, smooth to the touch and color fast, although other known materials, including plastic, rubber and the like, could be used to create a physical barrier strong enough to prevent a child or adult from going under body 7 between front wheels 12 or between front and rear wheels 12 and 22. In addition, it would be possible to manufacture at least a portion of safety guard 50 or 55 from recycled tire rubber or fiberglass. To reduce the weight and thickness of the safety guard 50 or 55, it is possible to employ an inner wire mesh for internal strengthening without sacrificing overall effectiveness.

At this point, it should be recognized that safety guards 50, 52 and 55 mount to and extend downward from different portions of vehicle 2 for engaging animate and inanimate objects in order to prevent the objects from going under vehicle 2. In the exemplary embodiment shown, frontal safety guard 50 is designed to extend along front end 8 below bumper 14, while slightly wrapping around front corners (not labeled) of vehicle. Forward side safety guard 52 extends below forwardmost side door 15, basically to a front portion of wheel well 13. On the other hand, safety guard 55 is elongated and extends below side panel 33 essentially entirely between wheel wells 13 and 30 of front and rear wheels 12 and 22 respectively. Therefore, between safety guard 50, safety guard 52 and safety guard 55, the entire areas across the front and side of vehicle 2 are protected. Regardless, for purposes of the invention, one or more of safety guards 50, 52 and 55 can be provided and each guard 50, 52 and 55 can actually be formed of multiple pieces which can be advantageous in connection with the need to replace a safety guard portion due to in-use damage as discussed further below. In any case, the particular circumferential vehicle coverage and mounting of safety guard 50, 52 and/or 55 to body 7 can also greatly vary and does limit the invention.

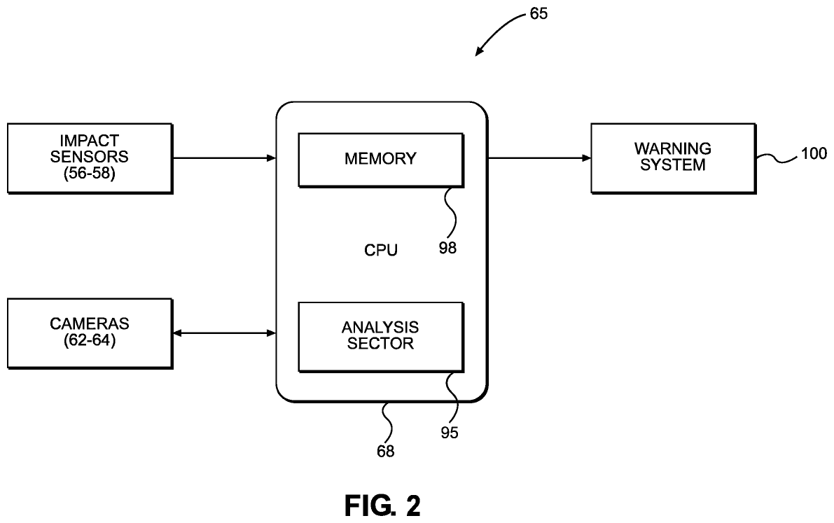

Important in connection with the present invention is the inclusion of an overall impact detection, analyzing and reporting system in combination with a safety guard system. In general, the invention encompasses two main impact detection aspects which can be used individually or in combination. The first aspect concerns maintaining the integrity of the safety guard system by sensing any impacts with any portion of the safety guard. Impact information is collected and analyzed to determine if one or more portions of the safety guard needs to be replaced. The second aspect of the invention concerns utilizing the impact information to determine the cause of the impact and to assess whether the operator of the vehicle was acting negligently. To carry out these aspects of the invention, safety guards 50, 52 and 55 themselves are provided with both a series of spaced impact sensors, such as one shown at 56 for frontal safety guard 50, 57 for forward side safety guard 52, and 58 for elongated side safety guard 55. In addition, each portion of safety guard system includes one or more guard mounted cameras, such as the one shown at 62 for frontal safety guard 50, 63 for forward side safety guard 52, and 64 for elongated side safety guard 55. The use of impact sensors 56-58 and cameras 62-64 will be detailed with particular reference to FIG. 2.

A control system for determining and assessing the occurrence of a safety guard impact is generally shown at 65 in FIG. 2. As illustrated, control system 65 includes a controller or CPU 68, i.e., control unit, mounted on vehicle 2. The features performed by controller 68 can be combined into a main vehicle controller, linked to the same or be separate therefrom, and actually can be integrated into the safety guard system itself. In any case, controller 68 receives signals from respective impact sensors 56-58 upon the occurrence of a safety guard impact with an animate or inanimate object. To this end, impact sensors 56-58 can take various forms know in the art of sensors, such as stress or strain sensors, load cell, pressure and the like sensors. Preferably, essentially immediately upon a sensor reading, a respective one or more of cameras 62-64 are activated to input additional impact information to CPU 68. In the alternative, cameras 62-64 can be active during use of vehicle 2, such as whenever the engine of vehicle 2 is running or when the vehicle is moving. In any case, all of the sensor and camera information is initially stored in memory 98. If cameras 62-64 are continuously active during use of vehicle 2, data stored in memory 98 without the signaling of an impact from one or more sensors 56-58 will be periodically purged.

CPU 68 also includes an analysis sector 95 which, upon a signal from one or more of the impact sensors 56-58, will automatically perform an initial assessment or evaluation of the impact, i.e., verifying the impact by cross-referencing different pieces of data, evaluating the degree of the impact based on the data, and determining the potential for damage to one or more portions of the safety guard system based on the impact. Any light impact, at a minimum, preferably sets off a lower-level warning through warning system 100, but stronger impacts which could have done damage to the safety guard system and potentially warranting a repair or replacement to the safety guard system will result in a higher level warning. Of course, various other warning levels can be established. In any case, analysis sector 95 can differentiate between location and type/degree of hits, e.g., curbs, potholes, speed bumps, objects in the road, etc. based on stored comparative data and/or using AI or machine learning, in order to establish the appropriate warning level.

The warnings can be established in various ways. In a simple electronic form, the vehicle driver can receive an audible and/or visible warning, such as a yellow light warning signal on the dashboard for the lower-level warning and a red light warning signal for the higher level warning. In connection with warning system 100, the warning certainly need not be limited to notifying a vehicle driver. Instead, in accordance with preferred embodiments of the invention, information on impacts is sent to a remote monitoring or service station, e.g., dispatch, supervisory or other company personnel, either directly from vehicle 2 after analysis by CPU 68 or automatically upon return of vehicle 2 to a vehicle depot. In connection with this remote transfer of data/information, preferably by wireless transmission like Wi-Fi, Bluetooth, NFC, RFID, satellite, cell transmission, etc., additional details on the cause of the impact can be determined, particularly whether the impact was due to operator error or negligence. Standards are set for the operator. For example, if a higher warning level signal is received, vehicle 2 must be immediately inspected or possibly even removed from service for further inspection/repair.

Based on the above, it should be readily apparent that the invention establishes a physical barrier or guard mounted securely to the undercarriage, body, frame, chassis, etc. which closes a potentially dangerous gap from below a front bumper and/or a rocker panel to a road surface to prevent pedestrians, cyclists and the like from entering the undercarriage of the vehicle in order to prevent injury or fatalities caused by the person being run over by the front or rear wheels. Important to the invention, the guard includes one or more sensors for capturing impact information that would provide information enabling a determination to be made regarding damage to the barrier and/or negligent operation of the vehicle by an operator. Embedded sensors in the guard could be employed to automatically trigger notifications to the vehicle operator or other supervisory or transit authority that the guard needs to be replaced because of wear or damage. The degree of impact, guard impact location and travel recordings can be logged for further analysis.

Although described with reference to preferred embodiments of the invention, it should be readily understood that various changes and/or modifications can be made to the invention without departing from the spirit thereof. For instance, the invention is not limited to the preferred impact and camera sensing arrangements but can include, by way of example, other sensors such as position and speed data sensors which could be logged and recorded for the desired analyses.

1. A vehicle comprising:
a body having a front end portion and a side panel portion;
a pair of front steerable wheels spaced in a transverse direction of the body of the vehicle;
at least one pair of transversely spaced rear wheels which are longitudinally spaced from the front steerable wheels;
a door provided along the at least one side panel;
a safety guard configured to extend downward from the body along one of the front end portion and the side panel portion for engaging animate and inanimate objects in order to prevent the objects from going under the vehicle; and
a detection system including a plurality of sensors configured to sense an impact experienced by the safety guard and a control unit for analyzing the impact.

2. The vehicle of claim 1, wherein the plurality of sensors include both impact sensors and cameras.

3. The vehicle of claim 2, wherein at least the impact sensors are built into the safety guard.

4. The vehicle of claim 2, wherein both the impact sensors and cameras are part of the safety guard.

5. The vehicle of claim 1, wherein the control unit is configured to determine a likelihood of damage to the safety guard by the impact.

6. The vehicle of claim 5, further comprising a warning system for issuing at least one of an audible or visual warning when an impact is experienced by the safety guard.

7. The vehicle of claim 6, wherein the audible or visual warning is presented to an operator of the vehicle.

8. The vehicle of claim 6, wherein the audible or visual warning is presented as a notification to a remote supervisory or service center.

9. A safety guard configured to extend downward along one of a front end portion and the a panel portion of a vehicle body for engaging animate and inanimate objects in order to prevent the objects from going under the vehicle, said safety guard incorporating a detection system including a plurality of sensors configured to sense an impact experienced by the safety guard and to signal a control unit for analyzing the impact.

10. The safety guard of claim 9, wherein the plurality of sensors include both impact sensors and cameras.

11. The safety guard of claim 10, wherein at least the impact sensors are built into the safety guard.

12. The safety guard of claim 10, wherein both the impact sensors and cameras are part of the safety guard.

13. A method of detecting an impact to a safety guard extending downward from one of a front end portion and a side panel portion of a body of a vehicle having a pair of front steerable wheels spaced in a transverse direction of the body of the vehicle, at least one pair of transversely spaced rear wheels longitudinally spaced from the front steerable wheels, and a door provided along the at least one side panel, said method comprising:
sensing an impact experienced by the safety guard with a plurality of sensors; and
analyzing signals from the plurality of sensors in evaluating the impact.

14. The method of claim 13, wherein the plurality of sensors are built into the safety guard.

15. The method of claim 13, wherein the plurality of sensors include both impact sensors and cameras.

16. The method of claim 13, wherein evaluating the impact includes determining a likelihood of damage to the safety guard by the impact.

17. The method of claim 16, automatically triggering a notification when the guard needs to be replaced because of wear or damage.

18. The method of claim 13, further comprising issuing at least one of an audible or visual warning when an impact is experienced by the safety guard.

19. The method of claim 18, wherein the audible or visual warning is presented to an operator of the vehicle.

20. The method of claim 18, wherein the audible or visual warning is presented as a notification to a remote supervisory or service center.

21. The method of claim 13, wherein evaluating the impact includes analyzing a cause of the impact, including whether the impact was due to vehicle operator error.
